(19) United States
(12) Patent Application Publication
(10) Pub. No.: US 2025/0077949 A1
(43) Pub. Date: Mar. 6, 2025

(54) SYSTEMS AND METHODS FOR MACHINE LEARNING MODEL RETRAINING

(71) Applicant: American Express Travel Related Services Company, Inc., New York, NY (US)

(72) Inventors: Karthikeyan Ponnalagu, Bengaluru (IN); Mohit Jain, Gurgaon (IN); Shikha Agrawal, Bengaluru (IN); Gaurav Vijay, Gurgaon (IN)

(21) Appl. No.: 18/458,114

(22) Filed: Aug. 29, 2023

(51) Int. Cl. G06N 20/00

(52) U.S. Cl. CPC G06N 20/00

(57) ABSTRACT

Systems and methods for machine learning model retraining is described. In one example, a system includes a computing device that is configured to determine an anomaly score from a first input of a featurized data set for a machine learning model of a deployment environment. The computing device is configured to determine a feature correlation score for the machine learning model based at least in part on a second input of a featurized historical data set for the machine learning model. A model retraining frequency time period for the machine learning model is determined based at least in part on the feature correlation score and the anomaly score.

### BACKGROUND

Machine learning models are trained, tested, and deployed for use in a particular use-case scenario. As new data becomes available over time, machine learning models can be retrained by a data scientist. The new data may include data elements representing new scenarios, new data trends, a change in a relationship between inputs to outcomes, and other new dynamic developments.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a drawing of a block diagram of operations for a computing environment in FIG. 1 according to various embodiments of the present disclosure.

FIG. 3 is an example of a retraining scenario executed in the networked environment of FIG. 1 according to various embodiments of the present disclosure.

FIG. 4 is a flowchart illustrating one example of functionality implemented as portions of an application executed in a computing environment in the network environment of FIG. 1 according to various embodiments of the present disclosure.

### DETAILED DESCRIPTION

The present disclosure relates to systems and methods for retraining a machine learning model for a deployment environment. Machine learning models are trained, tested, and deployed for use in a particular use-case scenario. After machine learning models are deployed, new data becomes available from a variety of data sources, such as feedback sources, newly discovered scenarios, new trends, new variables, and other suitable data sources for new data. As the new data becomes available overtime, machine learning models can be retrained by a data scientist.

However, it can be difficult to determine when a machine learning model should be retrained. If a machine learning model is retrained too frequently, then computing resources can be wasted, and the benefits (e.g., relating to improved model accuracy levels) may be of minimal value. Conversely, if the machine learning model is not retrained frequently enough, then the machine learning model may not have sufficient accuracy for its intended application.

Also, data scientists of a machine learning model may not have a sufficient understanding of which changes in variables, parameters, or values in a large data set are likely to have a significant impact on the machine learning model's ability to accurately predict a desired outcome. As such, a determination of when to retrain a machine learning model can be more complex than merely determining a retraining frequency for the machine learning model because of unpredictable changes in certain variables and the dynamic relationships between certain variables can be a significant factor for the accuracy of a model. In addition, as new data becomes available, the data preparation process for new data can be time-consuming for a data scientist if the new data is raw or unorganized.

To address these issues, various embodiments of the present disclosure introduce approaches for systematically determining various retraining characteristics for particular deployed machine learning model. For example, the embodiments can determine retraining characteristics such as a predicted frequency for retraining a machine learning model and determining an opportune point for replacing an existing machine learning model with a challenger model for a particular deployment environment. Further, the retraining characteristics can be used for automating certain retraining tasks, such initiating a retraining process according to a predicted retraining frequency or deploying a candidate model in replacement of an existing deployed model according to a model replacement decision.

The embodiments may be capable of achieving certain advantages over prior approaches. First, the embodiments can reduce the amount of computing resources used for retraining machine learning models because a retraining frequency can be dynamically determined based at least in part on the dynamic changes in the input data over time for a machine learning model. Each retraining effort can consume considerable computing resources (e.g., in memory and computer processing capability). As such, a reduction a computing resources used for retraining machine learning models can improve the functionality and the efficiency of a computing system.

Second, the embodiments can improve the accuracy of machine learning model predictions over time because the embodiments can identify the dynamic changes in the input data and model performance data (e.g., in real-time or on an interval basis). Third, the embodiments can establish a systematic process for replacing an existing machine learning model with a challenger model for a particular deployment environment. Fourth, the embodiments can establish a framework that generates multiple outputs that can be used for automating the retraining process of a deployed machine learning model.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

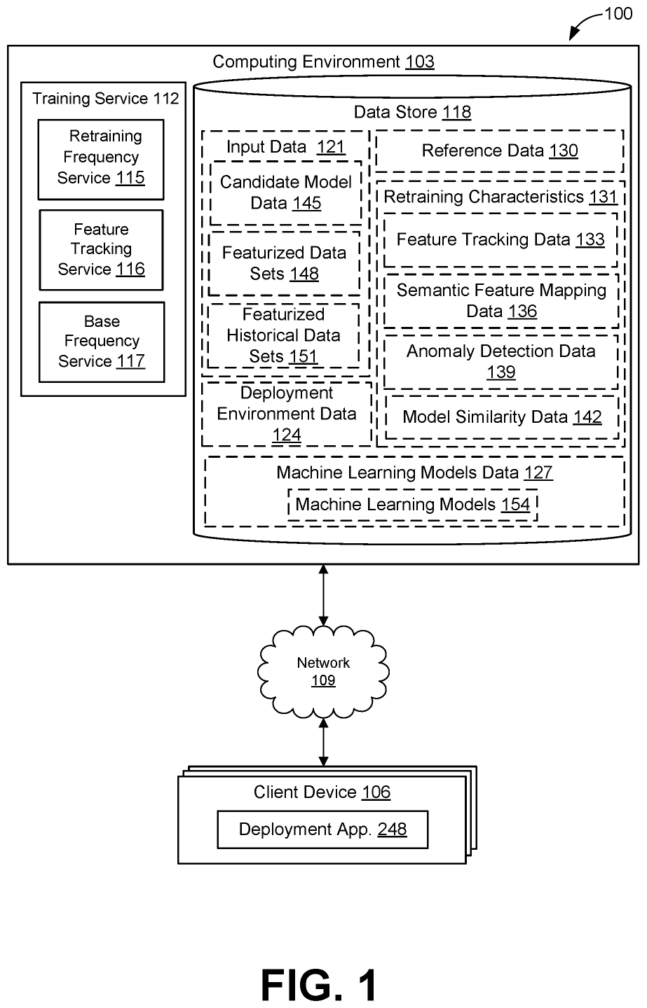

As illustrated in FIG. 1, shown is a drawing of a network environment 100 for systematically retraining a machine learning model. The network environment 100 can include a computing environment 103, and a client device 106, which can be in data communication with each other via a network 109.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed in the computing environment 103 include a training service 112, and other applications, services, processes, systems, engines, or functionality not discussed in detail herein. The training service 112 can be executed to determine various aspects related to retraining and deploying a particular machine learning model. For example, the training service 112 can be executed to determine a frequency of retraining the machine learning model, determining whether to replace an existing machine learning model with a challenger mode, notifying model developers of the retraining of certain machine learning models, and suitable services. The training service 112 can be used to automate retraining tasks of a machine learning model.

The training service 112 can include a retraining frequency service 115, a feature tracking service 116, a base frequency service 117, and other suitable services. The retraining frequency service 115 can be executed to determine a frequency of retraining a particular machine learning model for a deployment environment based at least in part on a criteria. The feature tracking service 116 can be executed to determine correlation data and important data for features of a targeted outcome. The base frequency service 117 can be executed to generate and/or display model performance data on a client device 106. The base frequency service 117 can also be executed to specify a base line frequency.

Also, various data is stored in a data store 118 that is accessible to the computing environment 103. The data store 118 can be representative of a plurality of data stores 118, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 118 is associated with the operation of the various applications or functional entities described below. This data can include input data 121, deployment environment data 124, machine learning models data 127, reference data 130, retraining characteristics 131, and potentially other suitable data.

The retraining characteristics 131 can represent data that is generated during one or more analysis processes by the training service 112 for determining parameters for retraining a particular machine learning model in a deployment environment. The retraining characteristics 131 can include feature tracking data 133, semantic feature mapping data 136, anomaly detection data 139, model similarity data 142, and potentially other data. Some non-limiting examples of retraining characteristics 131 can include model replace/retain decisions, retraining model frequencies, model repository assessments, notifications for operators of related models, model performance analysis, and other suitable retraining characteristics 131.

The input data 121 can represent data that is provided to the training service 112 for determining retraining characteristics 131 for a particular machine learning model. The input data 121 can include candidate models data 145, featurized data sets 148, featurized historical data sets 151, and other suitable input data 121 for the training service 112.

The candidate models data 145 can represent challenger candidate models that have been generated for potentially replacing an existing machine learning model based at least in part on a criteria. Individual challenger candidate models can be evaluated to determine whether each model should replace the current machine learning model that is used in a deployment environment. In some examples, the candidate challenger models can represent potential machine learning models that have yet to be tested and evaluated for model performance. The candidate challenge models may be generated by a machine learning algorithm. Some non-limiting examples of machine learning algorithms include a linear regression, logistic regression, a decision tree, an artificial neural network, k-nearest neighbors, k-Means, and other suitable machine learning algorithms.

The featurized data sets 148 can represent raw data that has been prepared for machine learning processing. Typically, raw data may go through data preparation before a machine learning model can use the raw data. The featurized data sets 148 can represent raw data that has been organized, scaled, normalized, labeled, and/or other suitable data preparation processes. As such, in some examples, the featurized data sets can generated by converting raw data into a data set with features. The features can represent one or more numeric representations of raw data. Features can be data attributes, data properties, or data characteristics of the raw data. In some examples, each feature can be representative of a column in a data set.

The featurized historical data sets 151 can represent featured data sets 148 that have been previously processed by a machine learning model, by the training service 112, or other suitable machine learning processing. Accordingly, in some embodiments, the featurized historical data sets 151 can include previous featurized data sets 148 that have been processed by one or more machine learning models.

The deployment environment data 124 can represent data associated with a deployment environment for a deployed machine learning model. The deployment environment data 124 can represent the parameters, criteria, and other suitable data to represent a particular use-case scenario for the deployment of a machine learning model. In some instances, the deployment environment data 124 can describe a production environment for the deployed machine learning model. For example, the machine learning model can be deployed in a server, a cloud computing service, a laptop, a mobile device, an edge device, and other suitable devices. The differences in the computing environment 103 and the particular use of the machine learning model can cause the machine learning model to be used in a manner that prioritizes certain criteria, such as real-time predictions, batch predictions, minimizing compute processing, and other suitable factors associated with the deployment environment.

The machine learning models data 127 can represent data associated with one of more machine learning models 154 that are deployed in a deployment environment. The machine learning model 154 can be a file that has been trained to recognize certain types of patterns. In some examples, the machine learning models 154 are the outputs (e.g., an output file) from a machine learning algorithm that has processed or run on input data 121. Each machine learning model 154 can represent learned data and a series of instructions for executing a task, such as a prediction, a classification, and other suitable machine learning tasks.

The training service 112 is executed to determine various aspects related to retraining these machine learning models 154. For example, the training service 112 can be executed to determine a frequency for retraining the machine learning model 154, determine whether to replace a deployed machine learning model 154 with a challenger model for a deployment environment, notify model users of retraining characteristics 131 for a particular machine learning model 154, and other suitable aspects.

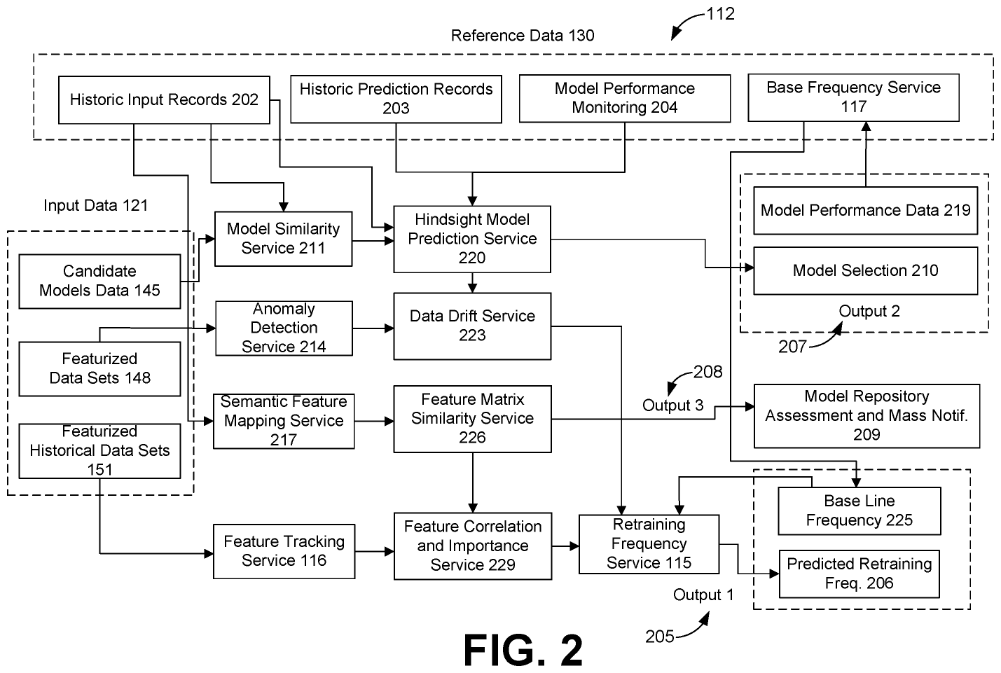

The reference data 130 can represent existing model data that is updated over a period time and used as a reference to determine one or more outputs (see e.g., FIG. 2 (205, 207, 208)). The reference data 130 can include historic input records (e.g., previous retain/replace model decisions, previous input data sets), historic prediction records, model monitoring data (e.g., real-time or near real-time model performance, feedback model performance), base frequency heuristics data, and other suitable data elements. The training service 112 can use the reference data 130 at different stages of analysis for determining the retraining characteristics 131.

The feature tracking data 133 can represent feature correlation and importance data generated from the featurized historical data sets 151 and other factors. The feature tracking data 133 can indicate correlations between various features or variables in the data set and can also indicate an importance of a particular feature for an outcome/output of the machine learning model 154. For example, a first feature and a second feature of a data set have an outcome correlation that changes over a period of time as new data sets become available. Additionally, the first feature may have a first importance score for the outcome and the second feature may have a second importance score for the outcome.

The semantic feature mapping data 136 can represent a mapping of data characteristics or features that have similar meanings. For example, a first feature and a second feature may have different labels, but the first feature and second feature represent similar data characteristics from the data set.

The anomaly detection data 139 can represent characteristics associated with detected anomalies in a data set. For example, the anomaly detection data 139 can include a quantity of detected anomalies, an identification of the detected anomalies (e.g., outlier data points), trends (e.g., data drift) over a time period associated with the quantities of detected anomalies, and other suitable anomaly detection data. As such, the anomaly detection data 139 can be generated by the training service 112 to describe a change in the relationship between input data 121 and output data in the deployment environment.

The model similarity data 142 can represent similarity metrics that describe the similarity between various machine learning models 154. In some instances, the similarity metrics can describe the model performance similarity between a candidate challenger model and a deployed machine learning mode. The model similarity data 242 can be used to determine whether the candidate challenger model should replace an existing deployed machine learning model 154.

The client device 106 is representative of a plurality of client devices that can be coupled to the network 109. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can be configured to execute various applications such as a deployment application 248, a client application, or other applications. The deployment application 248 can be used to facilitate the deployment of a machine learning model 154 at the client device 106 (e.g., a mobile device, a laptop, a tablet, an edge device, etc.). The deployment application 248 can be in data communication with the training service 112. The deployment application 248 can provide model performance data to the training service 112. Additionally, the client application can be executed in a client device 106 to access network content served up by the computing environment 103 or other servers, thereby rendering a user interface on the display. To this end, the client application 248 can include a browser, a dedicated application, or another executable, and the user interface can include a network page, an application screen, or another user mechanism for obtaining user input. The client device 106 can be configured to execute applications beyond the client application 248 such as email applications, social networking applications, word processors, spreadsheets, or other applications.

Next, a general description of the operation of the various components of the network environment 100 is provided. Although the following description provides an example of the interactions between the various components of the network environment 100, other interactions between the components of the network environment 100 are also encompassed by the various embodiments of the present disclosure.

To begin, the network environment 100 can be configured to determine retraining characteristics 131 for a deployed machine learning model 154. The training service 112 can be configured to retrieve, collect, or generate input data 121 and reference data 130 in order to generate the retraining characteristics 131 of a deployed machine learning model 154.

As previously indicated, the input data 121 can include candidate models data 145, the featurized data sets 148, the featurized historical data sets 151, and other suitable input data 121. One or more data preparation techniques can be employed to generate portions of the input data 121. The reference data 130 can include historical input records, historic prediction records, model performance monitoring, and other suitable reference data 130. The reference data 130 can be generated over a period of time as the deployed machine learning model's 154 retraining characteristics 131 are generated. The deployment environment data 124 can indicate parameters associated with a deployment environment of the deployed machine learning model 154. For instance, the deployment environment may be an embedded environment, such as the client device 106 (e.g., an edge device or a personal computer), and the parameters may include a device type, an operating system, and other embedded parameters. In another example, the deployment environment can be one or more servers and there can be server parameters for deploying the model this particular environment.

In a first non-limiting example, the training service 112 can be executed to generate a predicted retraining frequency, which can be one of multiple retraining characteristics 131 generated by the training service 112. In this example, the training service 112 can use a feature tracking service to generate feature tracking data 133. The feature tracking data 133 can indicate the feature correlations between variables and feature correlations to a target outcome. With the initial feature correlation data, the training service 112 can generate feature correlation and importance data based at least in part on the semantic feature mapping data 136. The feature correlation and importance data can be useful for feature selection because the data can be useful for removing redundant features and identifying highly correlated features for a target outcome (e.g., predicted retraining frequency).

The training service 112 can generate the anomaly detection data 139 from the featurized data sets 148. The anomaly detection data 139 can include a quantity of statistical anomalies detected in the featurized data sets 148 and drift data. The drift data can represent changes in the anomalies detected over a period of time.

In some instances, the training service 112 can generate a predicted retraining frequency value based at least in part on the feature correlation and importance data, the relevant drift data from the anomaly detection data 139, and the heuristic frequency (e.g., a specified base line frequency). In other instances, the training service 112 can provide these data elements to the retraining frequency service 115 for determining the predicted retraining frequency value.

In a second non-limiting example, the training service 112 can be executed to determine a model selection between a candidate challenger model and the deployed machine learning, which can be one of multiple retraining characteristics 131 generated by the training service 112. The training service 112 can generate and/or store a collection of candidate challenger models as candidate models data 145. In some instances, the training service 112 can identify a candidate challenger model from the collection of candidate challenger models. The candidate challenger model can be selected based at least in part on a ranking of the collection of candidate challenger models or a selection criteria.

The training service 112 can determine a model selection between the selected candidate challenger model and the deployed machine learning model 154. The model selection can represent a decision to either retain the deployed machine learning model 154 or replace the deployed model with a candidate challenger model.

The training service 112 can generate the model selection based at least in part on one or more factors, such as the model similarity data 142, reference data 130 (e.g., the historic input records, historic prediction records, model performance records), and other suitable data.

In a third non-limiting example, the training service 112 can be executed to transmit a notification to interested users of newly generated retraining characteristics 131. The training service 112 can identify a threshold for sending a notification based at least in part on a threshold being met for one or more of the retraining characteristics 131 (e.g., the semantic feature mapping data, the feature tracking data 133, the model similarity data, a model selection, a predicted retraining frequency). The training service 112 can identify contact information of users interested in a related machine learning model.

For example, the training service 112 can identify one or more related machine learning models 154. The related machine learning models 154 can include a model dependent on the deployed machine learning model 154, a model with similar performance, a model operating in a similar deployment environment, and other suitable related models. The training service 112 can retrieve the contact information (e.g., an email address, a device identifier, etc.) of a list of interested model operators (e.g., a model developer, data scientist, an operator, or other users associated with the related models). The training service 112 can transmit a notification to the list of interested model operators. The notification can include an identifier for the deployed machine learning model 154 and the feature similarity data.

In some embodiments, the training service 112 can be configured to automate one or more retraining machine learning model tasks or services based at least on part on the generated retraining characteristics 131. For example, after the predicted retraining frequency has been generated. The deployed machine learning model 154 can be retrained in an automated manner according to the retraining frequency. The input data 121 can be used to retrain machine learning model 154 using a machine learning algorithm in order to generate a retrained machine learning model file, which can be transmitted to the deployment environment.

In some example implementations, there can be a job scheduler running real time to traverse a data store 118 storing collection of triplets of model frequency, model file and training and testing data file locations. The model frequency key of the triplet can continuously be updated by the proposed training frequency regeneration engine in each separate thread. The job scheduler can compare the triplet with a replicated cache store to see if there is a change from a last run. If there is a change and the new refreshed frequency meets the criteria, job scheduler can trigger the training service 112 to execute for retraining the model file with new training and test data. The training service 112 can also update the cache store with the new frequency update. If the training or test data is not updated since last run, the training service 112 can alert the user to update the training and test data files accordingly. This approach can ensure that the training service 112 is optimally executed to minimize the retraining instances. For example, the retraining instances can be optimized to the bare minimum required.

In addition, the training service 112 can be executed to automate the deployment of a candidate model that has been determined to replace a deployed machine learning model 154 based at least in part on a model selection determined by the training service 112. After the model selection has been determined, the training service 112 can transmit the candidate model to the deployment environment. Once the training service 112 completes the retraining of the model file, the training service 112 can generate the revised model performance data on the new training and test data. The existing model file can also be executed on the new test data. The training service 112, via model performance comparator, can be executed to compare the performance metrics of the new model file with the existing model file to decide if the new model file have exceeded the threshold performance of the old model file. If the new model file has exceeded the threshold performance, the training service 112 can be notified to initiate the deployment of the new model file.

In addition, the training service 112 can be executed to automate a mass notification to interested users of the generated retraining characteristics 131 (e.g., semantic feature mapping data 136, model similarity data 142, model performance analysis, etc.) for a deployed machine learning model 154. The mass notification module 209 can continuously monitor the changes in the list of continuously updated data like semantic feature mapping data 136 and model similarity data 142 and based on a configurable threshold value. If the change is exceeding the threshold, the mass notification module 209 (or the training service 112) can initiate mail alerts to all the registered email identifiers that are subscribed for such alerts. To ensure only the relevant model owners are alerted, the change can be evaluated for each instance of such data to identify the right targeted models. For example, if the feature mapping data change exceeds the threshold, then the mass notification module 209 can notify only the model owners of model files which are leveraging the list of features for the model retraining.

Referring next to FIG. 2, shown is a block diagram of the operations of the training service 112. FIG. 2 illustrates a flow of logic from inputs to output by way of various intermediary stages. As shown in FIG. 2, the training service 112 can be provided input in the form of input data 121 and reference data 130 at different stages of processing. The reference data 130 can include historic input records 202, the historic predictions records 203, model performance monitoring data 204, and other suitable reference data.

The historic input records 202 can include previous retain or replace decisions when comparing previous challenger models to a previous deployed model. The historic input records 202 can also include the previous data sets that were associated with the previous challenger models and/or the previous deployed model. Historic input records 202 can be the training and testing data that were previously provided as inputs by external users that were consumed by the training service 112 for retraining the models.

The historic predictions records 203 can represent previous predictions/decisions regarding whether to select the challenger model or the deployed model. The historic prediction records 203 can be the generated output data of models retrained in the previous iterations.

The model performance monitoring data 204 can represent the model performance data collected from a deployed machine learning model 154. In some examples, the model performance data can be collected in real-time while the machine learning model 154 is executed in a deployed environment. In some embodiments, the model performance data can be provided to the hindsight model prediction service 220.

The training service 112 can generate one or more outputs, such as a first output 205 for a predicted retraining frequency 206, a second output 207 for a model selection 210 between a challenger model or a currently deployed model, a third output 208 of a model assessment and mass notification 209, and other suitable outputs.

The training service 112 includes a model similarity service 211, an anomaly detection service 214, a semantic feature mapping service 217, the retraining frequency service 115, the feature tracking service 116, the base frequency service 117, the hindsight model prediction service 220, a data drift service 223, a feature matrix similarity service 226, a feature correlation and importance service 229, and other suitable retraining model services. Additionally, the various of components of the training service 112 can be implemented as a service, an application, a function, or another suitable component.

The model similarity service 211 can generate model similarity data 142 (e.g., similarity metrics) for one or more candidate challenger models. In some examples, the model similarity service 211 can generate a model similarity score that represents a performance comparison between the candidate challenger models and the deployed machine learning model 154. The hindsight model data can be useful for determining whether one of the candidate challenger models should replace the current machine learning model 154 that is deployed. The model similarity service 211 can generate the model similarity score based at least in part on one or more factors, such as candidate models data 145 and historic input records 202. Some non-limiting examples of a model similarity service 211 can include a cosine similarity, a Euclidean distance, a Pearson's correlation or correlation similarity, and other suitable similarity techniques.

The anomaly detection service 214 can generate anomaly detection data 139 for the featurized data sets 148. In some examples, the anomaly detection service 214 can generate a quantity of anomalies detected in a data set. The anomaly detection service 214 may also generate an anomaly detection score that represents an amount of anomaly detections for a data set. Some non-limiting examples of an anomaly detection service 214 can include supervised detection methods, unsupervised methods, semi-supervised methods, and other anomaly detection techniques. Additionally, the anomaly detection service 214 can include a density-based algorithm, a cluster-base algorithm, a Bayesian-network algorithm, a neural network algorithm, and other suitable anomaly detection algorithms.

The semantic feature mapping service 217 can generate semantic feature mapping data 136 from the historic input records 202. The semantic feature mapping data 136 can include mapping of data characteristics or features that have similar meanings. For example, a first feature and a second feature may have different labels, but the first feature and second feature represent similar data characteristics from the data set. In some instances, the semantic feature mapping service 217 can provide the semantic feature mapping data 136 to the feature matrix similarity service 226. Some non-limiting examples of the semantic feature mapping service 217 can include latent semantic analysis, pointwise mutual information analysis, and other suitable semantic feature mapping techniques.

In some embodiments, the semantics data can represent a glossary of terms. For example, in some instances, the semantic meaning of the data characteristics can change over different periods of time for a data set. In other instances, the data ranges for the data characteristics can change over time for the data set. In yet other instances, variables in different data currents can represent similar data even though the label names different. Conversely, variables with similar label names can represent data types of data characteristics.

The feature tracking service 116 can generate feature tracking data 133 for the featurized historical data sets 151. In some respects, the feature tracking service 116 can represent one or more feature selection techniques. The feature tracking service 116 can identify correlation data for different features in the data set, which can be used to indicate how strongly features are correlated among each other. The feature tracking service 116 can generate feature correlation data based at least in part on the featurized historical data sets 151. In some examples, the feature correlation data can indicate a first correlation value between a feature and an outcome, a second correlation value between a first feature and a second feature, and other suitable feature tracking data 133. In some instances, the feature tracking service 116 can generate a feature correlation score (e.g., a numeric value) to represent one or more data elements of the feature correlation data.

The hindsight model prediction service 220 can generate hindsight model prediction data that indicates how previous model performance predictions compare to actual model performance. In some examples, the hindsight model prediction service 220 can generate second output 207, which can include a model selection between a particular challenger model and the deployed machine learning model 154. The hindsight model prediction service 220 can generate model performance data 219. In some instances, the hindsight model prediction service 220 can generate model performance data 219, which can include a hindsight model prediction score. Some non-limiting examples of hindsight model prediction service 220 can be similar in function to the training service 112 except that instead of assessing the retrained model file with newly provided test data, the hindsight model prediction service 220 can construct historic test data from randomly sampled historic input test data. Depending on the configuration, such testing can be repeated with different sets of historic test data that are either constructed newly or previously constructed and made available in the system, and other suitable model analysis techniques.

The data drift service 223 can generate data drift associated with the anomaly detection data 139, in which the data drift is stored in association with the anomaly detection data 139. The data drift relates to how the detected anomalies are drifting over a period of time for the featurized data sets 148. In some instances, the data drift represents a change related to the anomaly detection data 139 from a testing and validating stage to a deployment stage (e.g., production stage). The data draft can be generated based at least in part on the anomaly detection data 139 from the anomaly detection service 214 and based at least in part on the hindsight model prediction data from the hindsight model prediction service 220. In some non-limiting examples, the data drift service 233 can involve using a sequential analysis method (e.g., drift detection method, early drift detection method), a time distribution-based method, and other suitable data drift detection techniques.

The feature matrix similarity service 226 can generate feature similarity data from performing a feature matrix similarity analysis of the semantic feature mapping data 136. The feature similarity data can be provided to the feature correlation and importance service 229. In some non-limiting examples, the feature matrix similarity service 226 can include Euclidean distance, cosine, Manhattan, and other suitable feature matrix similarity techniques.

The feature correlation and importance service 229 can generate data that indicates that feature correlation and feature importance with respect to an outcome. For example, one or more set of features may have a significant impact for predicting an outcome. In some non-limiting examples, the feature correlation and importance service 229 can generate a feature correlation/importance score for indicating how important statistically a feature is for predicting an outcome. Some non-limiting examples of the feature correlation and importance service 229 can involve statistical correlation scoring, coefficients calculated as part of linear models, decision trees, permutation importance scores, and other suitable feature importance techniques.

The retraining frequency service 115 can generate a predicted retraining frequency 206 as part of first output 205. The retraining frequency service 115 can generate first output 205 based at least in part on various inputs. For example, the retraining frequency service 115 can receive inputs from one or more of the feature correlation and importance service 229, the data drift service 223, a selected base line frequency 225, and other suitable inputs. The base line frequency 225 can represent a selected or an initial retraining frequency by a data scientists. The first output 205 can be displayed on a client device 106.

In some examples, the training service 112 can be automated to retrain the machine learning model 154 based at least in part on the predicted retraining frequency in the deployment environment. For example, the deployment environment can be an embedded environment (e.g., a client device 106), a server environment, an edger service environment or other suitable computing environments.

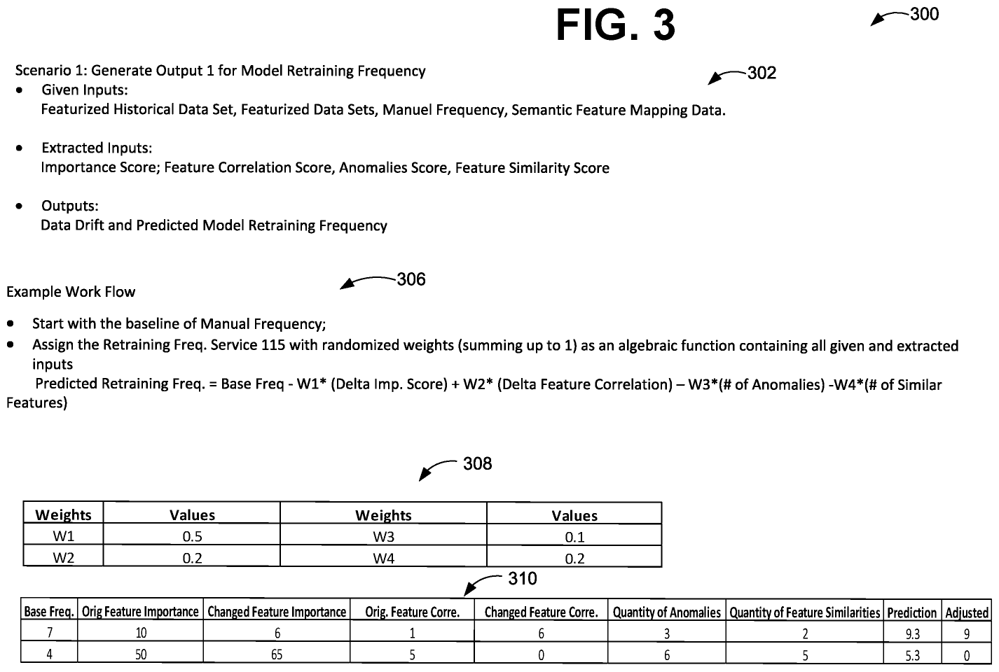

Turning now to FIG. 3, shown is a non-limiting example retraining scenario 300 for a machine learning model 154. FIG. 3 includes scenario information 302, an example workflow 306, a weight table 308, a retraining parameters table 310, and other suitable data.

In this example, the scenario information 302 describes the given inputs of featurized historical data sets 151, the featurized data sets 148, the semantic feature mapping data 136, the baseline manual frequency, and other suitable inputs. In other examples, the baseline manual frequency can be omitted.

The scenario information 302 also includes the extracted inputs and the output for this example retraining scenario 300. In this example, the extracted inputs can be an importance score, a feature correlation score, an anomalies score, a feature similarity score, and other suitable extracted inputs. The outputs include the data drift and the predicted model retraining frequency.

The example workflow 306 describes a few aspects of one non-limiting implementation of the retraining frequency service 115 for generating a predicted retraining frequency 206 as a first output 205. The example workflow 306 can be executed by the training service 112, the retraining frequency service 115, or other suitable services in the network environment 100. As shown, the example workflow 306 includes starting with a baseline manual frequency. The baseline manual frequency 206 can be selected by a developer or an operator for the machine learning model 154.

In one non-limiting example, the retraining frequency service 115 can be called by the training service 112 to generate a predicted model retraining frequency 206. The retraining frequency service 115 can generate a plurality of weights for the various factors for determining the predicted model retraining frequency 206. For instance, the retraining frequency service 115 can generate a first weight (W1) for an importance score, a second weight (W2) for a feature correlation, a third weight (W3) for a quantity of anomalies, a fourth weight (W4) for a quantity of similar features, and other suitable weights. The four weights can be randomly generated (e.g., by a random function) and the sum of the weights can add to a value of 1. In this non-limiting example, the predicted model retraining frequency 206 can be determined as an algebraic function. In this example, the algebraic function can be implemented as “Predicted retraining frequency=Base Freq.−W1*(Delta Importance Score)+W2*(Delta Feature Correlation Score)−W3*(Quantity of anomalies)−W4*(Quantity of Similar features).”

As such, the training service 112 can generate the delta importance score (e.g., change from a previous importance score) and the delta feature correlation score (e.g., change from a previous feature correlation score), quantity of anomalies, the quantity of similar feature, and other suitable data for computing the predicted retraining frequency 206. It should be appreciated above that the algebraic function, the weights, the coefficients, and other aspects can vary. In other embodiments, the retraining frequency service 115 can use a linear regressor technique to determine the weights of each of the factors.

Continuing with the previous example, the retraining frequency service 115 can determine weights (W1-W4) associated with a process for calculating the predicted model retraining frequency 206. In weight table 308, the weights W1-W4 are randomly selected.

Next, the retraining parameter table 310 illustrates two example calculations of the predicted model retraining frequency. The retraining parameter table 310 includes the base frequency, the original feature importance, the delta feature importance (i.e., changed feature importance), the original feature correlation, the quantity of anomalies, the quantity of feature similarities, the prediction of model retraining frequency, and the adjusted value. The adjusted value can be the newly generated training frequency value derived from the base frequency value by running the retraining frequency service 115.

The first example in the retraining parameter table 310 illustrates that the base frequency was too low after using the above-listed algebraic equation for predicted model retraining frequency 206. The base frequency starts with a base frequency of seven. Additionally, the first example indicates the change feature importance has a value of six from the original feature importance value of 10. The changed feature correlation value is six from the original feature correlation of 1. The quantity of anomalies is three and the quantity of feature similarities is two. With the weights from the weight table 308 and above-mentioned change inputs, the retraining parameter table 310 indicates that the retraining frequency service 115 has calculated a predicted retraining frequency to be 9.3 for the first example.

In the second example in the retraining parameter table 310, the retraining frequency service 115 illustrates a base frequency of 4. The changed feature importance is 65 and the changed feature correlation is zero. The quantity of anomalies is six and the quantity of feature similarities is five. With these values, the retraining frequency service 115 has generated a value of 5.3 for the predicted retraining frequency. In this example, if the predicted retraining frequency is less than zero, then the value implies that the retraining frequency is calculated for daily retraining for the machine learning model 154. If the predicted retraining frequency is greater than thirty, then the value implies that the retraining frequency is calculated for retraining on a monthly basis for the machine learning model 154.

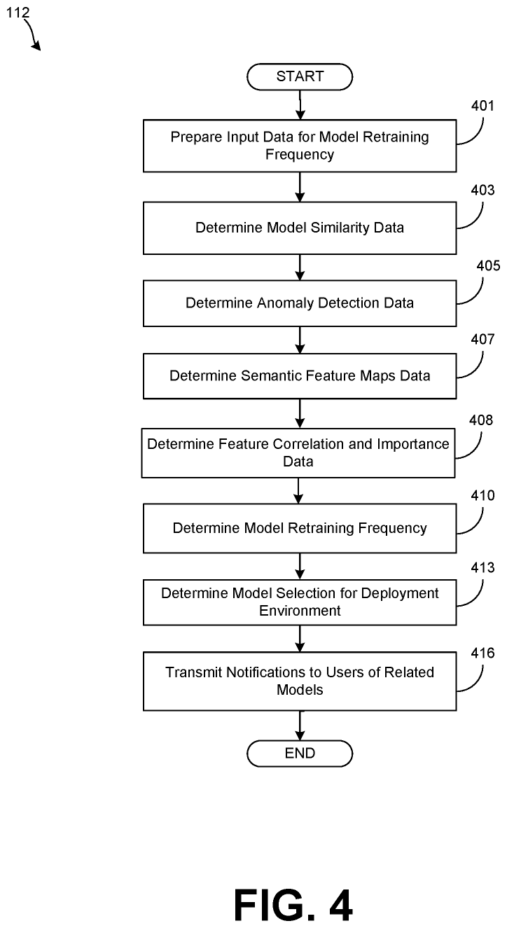

Referring next to FIG. 4, shown is a flowchart that provides one example of the operation of a portion of the training service 112. The flowchart of FIG. 4 provides merely an example of the many different types of functional arrangements that can be employed to implement the operation of the depicted portion of the training service 112. As an alternative, the flowchart of FIG. 4 can be viewed as depicting an example of elements of a method implemented within the network environment 100.

Beginning with block 401, the training service 112 can prepare the input data 121 in preparation for determining a predicted retraining frequency for a machine learning model 154. The machine learning model 154 can be a file that has been trained to recognize certain types of patterns and learned values associated the patterns. In some examples, the machine learning models 154 are one or more output files from a machine learning procedure (e.g., a machine learning algorithm) that has processed or run on input data 121. Each machine learning model 154 can represent learned data and a series of instructions for executing a task, such as a prediction, a classification, and other suitable machine learning tasks.

The training service 112 can prepare input data 121 by one or more data preparation techniques for machine learning. The input data 121 can include candidate models data 145, the featurized data sets 148, the featurized historical data sets 151, and other suitable input data 121. The candidate models data 145 can represent challenger candidate models that have been generated for potentially replacing an existing machine learning model 154 used in a deployment environment based at least in part on a criteria. In some examples, the candidate challenger models can represent potential machine learning models 154 that have yet to be tested and evaluated for model performance. The candidate challenge models may be generated by one or more machine learning algorithms.

The featurized data sets 148 can represent current raw data that has been prepared and in queue for machine learning processing. The featurized data sets 148 can represent raw data that has been organized, scaled, normalized, labeled, and/or other suitable data preparations. As such, in some examples, the featurized data sets 148 is generated by converting raw data into a data set with features. The features can represent numeric representation of raw data.

The featurized historical data sets 151 can represent featured data sets 148 that have been previously processed by a machine learning model 154, by the training service 112 or other suitable machine learning processing. Accordingly, in some embodiments, the featurized historical data sets 151 can include previous featurized data sets 148 that have been processed by one or more machine learning models 154.

In block 403, the training service 112 can determine model similarity data 142, such as a model similarity score, based at least in part on the candidate models data 145. The model similarity data 142 can represent a performance comparison between the candidate challenger models and the deployed machine learning models 154. In some embodiments, the training service 112 can execute a model similarity service 211 for generating the model similarity data 142.

In block 405, the training service 112 can determine anomaly detection data 139, such as a quantity of detected anomalies, based at least in part on the featurized data sets 148. The anomaly detection data 139 that represents an amount of anomaly detections for data set. The anomaly detection data 139 can also include an anomaly detection score, and/or other suitable anomaly detection data 139. In some examples, the training service 112 can execute an anomaly detection service 214 for generate the anomaly detection data 139. The featurized data set can be a time series of features that were generated from a data preparation process of raw data.

In block 407, the training service 112 can determine semantic feature mapping data 136, such as a similarity feature score, based at least in part on the historic input records 202. The semantic feature mapping data 136 can include a mapping of data characteristics or features that have similar meanings. In some examples, the training service 112 can execute a semantic feature mapping service 217 for generating the semantic feature mapping data 136.

In block 408, the training service 112 can determine the feature tracking data 133, which can include feature correlation data, the feature importance data, based at least in part on one or more factors. Some of the factors can include the featurized historical data sets 151, the semantic feature mapping data 136, feature similarity data, and/or other suitable data. In some instances, the training service 112 can execute the feature correlation and importance service 229 for generating the feature correlation and/or the feature importance data.

In some examples, the training service 112 can generate the feature correlation data based at least in part on the featurized historical data sets 151. The feature correlation data can include metrics that represent a relationship between two or more variables. The feature correlation data can be useful for reducing a number of variables for a machine learning model 154. For example, some variables may be selected because they have a high correlation (e.g., a statistical threshold) with an outcome. In another example, two variables may be highly correlated with each other. As such, one of the variables can be removed from selected group of variables (e.g., using a feature selection technique) for the machine learning model 154. The training service 112 can use feature selection techniques related to supervised methods (e.g., a wrapper technique, a filter technique, an intrinsic technique) and unsupervised methods (e.g., removing redundant variables).

In some examples, the training service 112 can generate the feature importance data based at least in part on the featurized correlation data and semantic feature mapping data 136 and/or other suitable data. The feature importance data can represent how the importance of a particular feature or variable is an outcome/output of the machine learning model 154. The feature importance data can represent how statistically correlated a feature is to an outcome.

In block 410, the training service 112 can determine a model retraining frequency 206 based at least in part on one or more factors. Some of the factors can include data drift from the anomaly detection data 139, heuristic frequency (e.g., a selected baseline frequency 225), feature correlation data, feature importance data, and other suitable retraining frequency data. In some embodiments, the training service 112 can execute the retraining frequency service 115 to determine the model predicted retraining frequency 206.

In block 413, the training service 112 can determine a model selection 210 for a deployment environment based at least in part on one or more factors, such as the model similarity data 142, the historic prediction records 203, the model performance monitoring data 204, the deployment environment data 124, and/or other suitable similarity data. The model selection 210 can represent whether one of the challenger machine learning models 154 should replace the existing machine learning model 154 for a deployment environment. In some examples, the model performance data 219 of the best challenger model can be compared to the model performance 219 of the existing machine learning model 154. The training service 112 can generate a model selection 210 (e.g., a retrain existing model or replace with the selected challenger model) based at least in part on the comparison.

In block 416, the training service 112 can transmit one or more notifications (e.g., third output 208 in FIG. 2) to users of the machine learning model 154 and related machine learning models 154 based at least in part on the feature similarity data generated from the training service 112 and/or the feature matrix similarity service 226. The training service 112 can identify one or more related machine learning models 154. The related machine learning models 154 can include a model dependent on the deployed machine learning model 154, a model with similar performance, a model operating in a similar deployment environment, and other suitable related models. The training service 112 can retrieve the contact information (e.g., an email address, a device identifier, etc.) of a list of interested model operators (e.g., a model developer, data scientist, an operator, or other users associated with the related models). The training service 112 can transmit a notification to the list of interested model operators. The notification can include an identifier for the deployed machine learning model 154 and the feature similarity data. Then, the training service 112 can proceed to the end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 4 the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowchart of FIG. 4 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowchart of FIG. 4 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system for machine learning model retraining, comprising:
at least one computing device comprising a processor and a memory; and
machine-readable instructions stored in the memory that, when executed by the processor, cause the computing device to at least:
determine an anomaly score from a first input of a featurized data set for a machine learning model of a deployment environment, the featurized data set being a time series of features and being generated from a data preparation process of raw data;
determine a feature correlation score for the machine learning model based at least in part on a second input of a featurized historical data set for the machine learning model, the featurized historical data set representing a previous data set that has been processed by the machine learning model, the feature correlation score indicating a change in an outcome correlation between a first variable and a second variable; and
determine a model retraining frequency time period for the machine learning model based at least in part on the feature correlation score and the anomaly score.

2. The system of claim 1, wherein the machine-readable instructions, when executed by the processor, cause the computing device to at least
determine a feature similarity score based at least in part on semantic feature map data derived from historic input records, the historic input records comprising a plurality of previous input data sets for the machine learning model.

3. The system of claim 2, wherein the machine-readable instructions further cause the computing device to at least:
determine a feature importance score for a plurality of individual features associated with the featurized historical data set based at least in part on the feature similarity score, wherein the model retraining frequency time period is further based at least in part on the feature importance score.

4. The system of claim 3, wherein the machine-readable instructions further cause the computing device to at least:
determine a related model to the machine learning model in the deployment environment based at least in part on the feature importance score; and
transmit a notification to a model user associated with the related model.

5. The system of claim 1, wherein the machine-readable instructions further cause the computing device to at least:
determine a model similarity score for a plurality of candidate models based at least in part on historic input records data that comprises a plurality of previous data sets and a plurality of previous model selection decisions.

6. The system of claim 5, wherein the machine-readable instructions further cause the computing device to at least:
determine a hindsight model prediction score based at least in part on the model similarity score for the plurality of candidate models and model performance data for the machine learning model in the deployment environment; and
determine a model selection for the deployment environment based at least in part on a comparison between the machine learning model deployed and the hindsight model prediction score for at least one of the plurality of candidate models.

7. The system of claim 6, wherein the machine-readable instructions further cause the computing device to at least:
determine a data drift frequency score associated with the featurized data set based at least in part on the hindsight model prediction score.

8. A method, comprising:
determining, by a computing device, an anomaly score from a first input of a featurized data set for a machine learning model in a deployment environment, the featurized data set being a time series of features and being generated from a data preparation process of raw data;
determining, by the computing device, a feature correlation score for the machine learning model based at least in part on a second input of a featurized historical data set for the machine learning model, the featurized historical data set representing a previous data set that has been processed by the machine learning model, the feature correlation score indicating a change in an outcome correlation between a first variable and a second variable; and
generating, by the computing device, a model retraining frequency time period for the machine learning model based at least in part on the feature correlation score and the anomaly score.

9. The method of claim 8, further comprising:
determining, by the computing device, a feature similarity score based at least in part on semantic feature map data derived from historic input records, the historic input records comprising a plurality of previous input data sets for the machine learning model.

10. The method of claim 9, further comprising:
determining, by the computing device, a feature importance score for a plurality of individual features associated with the featurized historical data set based at least in part on the feature similarity score, wherein the model retraining frequency time period is further based at least in part on the feature importance score.

11. The method of claim 10, further comprising:
determining, by the computing device, a related model to the machine learning model in the deployment environment based at least in part on the feature importance score; and
transmitting, by the computing device, a notification to a model user associated with the related model.

12. The method of claim 8, further comprising:
determining, by the computing device, a model similarity score for a plurality of candidate models based at least in part on historic input records data that comprises a plurality of previous data sets and a plurality of previous model selection decisions.

13. The method of claim 12, further comprising:
determining, by the computing device, a hindsight model prediction score based at least in part on the model similarity score for the plurality of candidate models and model performance data for the machine learning model in the deployment environment; and
determining, by the computing device, a model selection for the deployment environment based at least in part on a comparison between the machine learning model deployed and the hindsight model prediction score for at least one of the plurality of candidate models.

14. The method of claim 13, further comprising:
determining, by the computing device, a data drift frequency score associated with the featurized data set based at least in part on the hindsight model prediction score.

15. A non-transitory, computer-readable medium, comprising machine-readable instructions that, when executed by a processor of a computing device, cause the computing device to at least:
determine an anomaly score from a first input of a featurized data set for a machine learning model of a deployment environment, the featurized data set being a time series of features and being generated from a data preparation process of raw data;
determine a feature correlation score for the machine learning model based at least in part on a second input of a featurized historical data set for the machine learning model, the featurized historical data set representing a previous data set that has been processed by the machine learning model, the feature correlation score indicating a change in an outcome correlation between a first variable and a second variable; and
determine a model retraining frequency time period for the machine learning model based at least in part on the feature correlation score and the anomaly score.

16. The non-transitory, computer-readable medium of claim 15, wherein the machine-readable instructions, when executed by the processor, further cause the computing device to at least:
determine a feature similarity score based at least in part on semantic feature map data derived from historic input records, the historic input records comprising a plurality of previous input data sets for the machine learning model.

17. The non-transitory, computer-readable medium of claim 16, wherein the machine-readable instructions, when executed by the processor, further cause the computing device to at least:
determine a feature importance score for a plurality of individual features associated with the featurized historical data set based at least in part on the feature similarity score, wherein the model retraining frequency time period is further based at least in part on the feature importance score.

18. The non-transitory, computer-readable medium of claim 17, wherein the machine-readable instructions, when executed by the processor, further cause the computing device to at least:
determine a related model to the machine learning model in the deployment environment based at least in part on the feature importance score; and
transmit a notification to a model user associated with the related model.

19. The non-transitory, computer-readable medium of claim 15, wherein the machine-readable instructions, when executed by the processor, further cause the computing device to at least:
determine a model similarity score for a plurality of candidate models based at least in part on historic input records data that comprises a plurality of previous data sets and a plurality of previous model selection decisions.

20. The non-transitory, computer-readable medium of claim 19, wherein the machine-readable instructions, when executed by the processor, further cause the computing device to at least:
determine a hindsight model prediction score based at least in part on the model similarity score for the plurality of candidate models and model performance data for the machine learning model in the deployment environment; and
determine a model selection for the deployment environment based at least in part on a comparison between the machine learning model deployed and the hindsight model prediction score for at least one of the plurality of candidate models.
